(19) United States
(12) Patent Application Publication
(10) Pub. No.: US 2023/0066829 A1
(43) Pub. Date: Mar. 2, 2023

(54) SERVER DEVICE, CONFERENCE ASSISTANCE SYSTEM, AND CONFERENCE ASSISTANCE METHOD

(71) Applicant: NEC Corporation, Minato-ku, Tokyo (JP)

(72) Inventors: Shin NORIEDA, Tokyo (JP); Kenta FUKUOKA, Tokyo (JP); Masashi YONEDA, Tokyo (JP); Shogo AKASAKI, Tokyo (JP)

(73) Assignee: NEC Corporation, Minato-ku, Tokyo (JP)

(21) Appl. No.: 17/797,852

(22) PCT Filed: Feb. 28, 2020
(86) PCT No.: PCT/JP2020/008511

§ 371 Date: Aug. 5, 2022

(51) Int. Cl. G06F 40/166; G06F 40/279; G10L 15/30; G10L 15/22; G10L 15/26; G06F 16/68

(52) U.S. Cl. CPC G06F 40/166; G06F 40/279; G10L 15/30; G10L 15/22; G10L 15/26; G06F 16/686

(57) ABSTRACT

A server device according to an aspect of the present disclosure includes: at least one memory storing a set of instructions; and at least one processor configured to execute the set of instructions to: generate minutes of a conference from statements of participants; analyze the generated minutes, thereby extracting a conference state word indicating a state of a discussion in a conference; generate conference information based on the conference state word; and provide the generated conference information to a terminal.

### TECHNICAL FIELD

The present invention relates to a server device, a conference assistance system, a conference assistance method, and a program.

### BACKGROUND ART

Conferences, meetings, and the like in corporate activities and the like are important places for decision making. Various proposals have been made to efficiently hold conferences.

For example, PTL 1 discloses that content of a conference is capitalized to improve efficiency of conference operation. A conference assistance system disclosed in PTL 1 includes an image recognition unit. The image recognition unit recognizes an image related to each attendee from video data acquired by a video conference apparatus by using an image recognition technique. The system includes a voice recognition unit. The voice recognition unit acquires voice data of each attendee acquired by the video conference apparatus, and compares the voice data with feature information of the voice of each attendee registered in advance. The voice recognition unit specifies a speaker of each statement in the voice data based on the movement information of each attendee. The conference assistance system includes a timeline management unit that outputs, as a timeline, voice data of each of attendees acquired by the voice recognition unit in a time series of statements.

### CITATION LIST

### Patent Literature

[PTL 1] JP 2019-061594 A

### SUMMARY OF INVENTION

### Technical Problem

In a conference, particularly a conference over a long period of time, the directionality of a discussion may deviate from an original purpose. For example, even though the discussion of the technical trend related to “machine learning” is a purpose of the conference, the discussion may shift to the technical trend related to “quantum computer”. Although it may be natural transition in the discussion for parties at the conference, it is necessary for participants to be aware that the discussion is being conducted on a topic different from the original purpose. This is because, if a long time is spent on an agenda different from the original purpose, the time that can be allocated to the original purpose may be reduced.

Alternatively, at the end of a conference, the general management of the conference may be required. For example, in a conference where technical trends of machine learning are discussed, it may be necessary to share what topics (for example, the latest technology, trends of other companies, intellectual property strategies, and the like) have been discussed among all participants and create minutes or the like.

A main object of the present invention is to provide a server device, a conference assistance system, a conference assistance method, and a program that contribute to enabling participants to recognize discussion in a conference.

### Solution to Problem

According to a first aspect of the present invention, a server device is provided. The server device includes a generation unit that generates minutes of a conference from statements of participants; an extraction unit that analyzes the generated minutes, thereby extracting a conference state word indicating a state of a discussion in a conference; and a provision unit that generates conference information based on the conference state word and provides the generated conference information to a terminal.

According to a second aspect of the present invention, a conference assistance system is provided. The conference assistance system includes a terminal that is used by a participant in a conference; and a server device, in which the server device includes a generation unit that generates minutes of a conference from statements of participants, an extraction unit that analyzes the generated minutes, thereby extracting a conference state word indicating a state of a discussion in the conference, and a provision unit that generates conference information based on the conference state word and provides the generated conference information to the terminal.

According to a third aspect of the present invention, a conference assistance method for a server device is provided. The conference assistance method includes generating minutes of a conference from statements of participants; analyzing the generated minutes, thereby extracting a conference state word indicating a state of a discussion in a conference; and generating conference information based on the conference state word and providing the generated conference information to a terminal.

According to a fourth aspect of the present invention, a computer readable storage medium is provided. The computer readable storage medium stores a program causing a computer mounted on a server device to execute a process of generating minutes of a conference from statements of participants; a process of analyzing the generated minutes, thereby extracting a conference state word indicating a state of a discussion in a conference; and a process of generating conference information based on the conference state word and providing the generated conference information to a terminal.

### Advantageous Effects of Invention

According to each aspect of the present invention, the server device, the conference assistance system, the conference assistance method, and the program that contribute to enabling participants to recognize a discussion in a conference are provided. The effects of the present invention are not limited to the above description. According to the present invention, other effects may be achieved instead of or in addition to the above effects.

### BRIEF DESCRIPTION OF DRAWINGS

FIG. 1 is a diagram for describing an outline of an example embodiment.

FIG. 2 is a diagram illustrating an example of a schematic configuration of a conference assistance system according to a first example embodiment.

FIG. 3 is a diagram for describing connection between a server device and a conference room according to the first example embodiment.

FIG. 4 is a diagram illustrating an example of a processing configuration of the server device according to the first example embodiment.

FIG. 5 is a diagram illustrating an example of a processing configuration of a user registration unit according to the first example embodiment.

FIG. 6 is a diagram for describing an operation of a user information acquisition unit according to the first example embodiment.

FIG. 7 is a diagram illustrating an example of a user database.

FIG. 8 is a diagram illustrating an example of a participant list.

FIG. 9 is a diagram for describing an operation of a minutes generation unit according to the first example embodiment.

FIG. 10 is a diagram illustrating an example of minutes.

FIG. 11 is a diagram illustrating an example of a processing configuration of a conference room terminal according to the first example embodiment.

FIG. 12 is a diagram for describing an operation of an information provision request unit according to the first example embodiment.

FIG. 13 is a diagram for describing an operation of a conference information output unit according to the first example embodiment.

FIG. 14 is a sequence diagram illustrating an example of an operation of the conference assistance system according to the first example embodiment.

FIG. 15 is a diagram illustrating an example of a hardware configuration of a server device.

FIG. 16 is a diagram illustrating an example of a schematic configuration of a conference assistance system according to a modification example of the present disclosure.

FIG. 17 is a diagram illustrating an example of a schematic configuration of a conference assistance system according to a modification example of the present disclosure.

FIG. 18 is a diagram for describing an operation of the conference information output unit according to the first example embodiment.

FIG. 19 is a diagram for describing an operation of the conference information output unit according to the first example embodiment.

### EXAMPLE EMBODIMENT

First, an outline of an example embodiment will be described. The reference numerals in the drawings attached to this outline are attached to each element for convenience as an example for assisting with understanding, and the description of this outline is not intended to be limiting in any way. In a case where there is no particular explanation, the block described in each drawing represents not a configuration of a hardware unit but a configuration of a functional unit. Lines connecting blocks in each drawing include both bidirectional and unidirectional lines. A unidirectional arrow schematically indicates a flow of a main signal (data), and does not exclude bidirectionality. In the present specification and the drawings, elements that can be similarly described are denoted by the same reference numerals, and redundant description may be omitted.

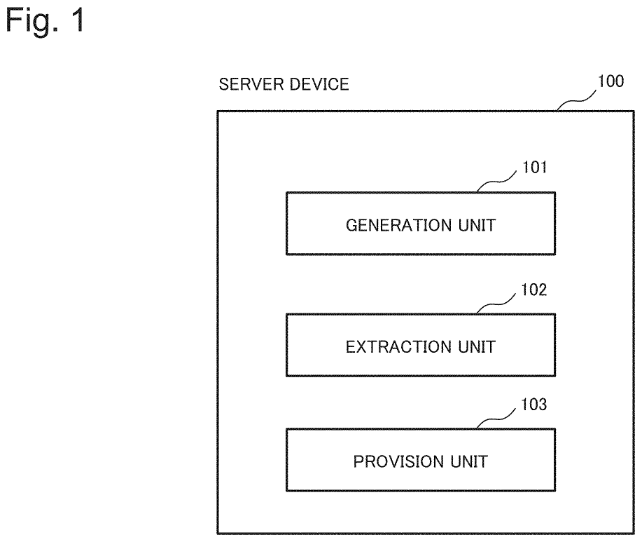

A server device 100 according to an example embodiment is provided with a generation unit 101, an extraction unit 102, and a provision unit 103 (refer to FIG. 1). The generation unit 101 generates the minutes of a conference from the statements of participants. The extraction unit 102 analyzes the generated minutes and extracts conference state words that represent a state of a discussion in the conference. The provision unit 103 generates conference information based on the conference state words and provides the generated conference information to a terminal.

While generating the minutes of the conference, the server device 100 analyzes the minutes to extract a keyword (conference state word; for example, a global word or a word of interest) that briefly indicates a state of the discussion in the conference from the minutes. The server device 100 provides the participants with the conference information (information indicating a discussion state in the conference) via terminals used by the participants in the conference. The participants who have contact with the conference information accurately ascertain the content (topics) being discussed at present, and refrain from making statements that are significantly different from a major purpose of the conference (a purpose of the conference). As a result, the participants can appropriately recognize the discussion in the conference.

Hereinafter, specific example embodiments will be described in more detail with reference to the drawings.

### First Example Embodiment

A first example embodiment will be described in more detail with reference to the drawings.

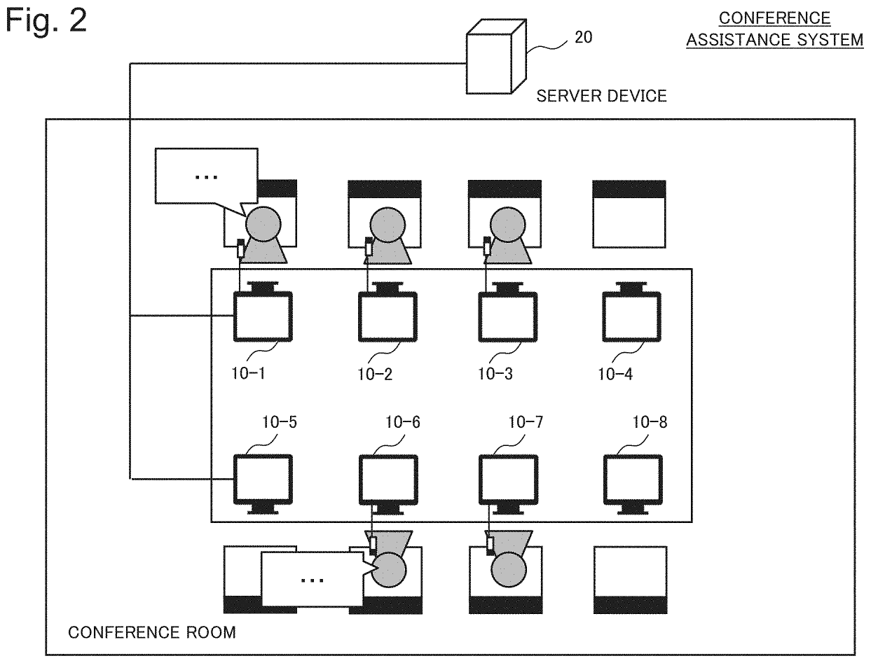

FIG. 2 is a diagram illustrating an example of a schematic configuration of a conference assistance system according to a first example embodiment. Referring to FIG. 2, the conference assistance system includes a plurality of conference room terminals 10-1 to 10-8 and a server device 20. It goes without saying that the configuration illustrated in FIG. 2 is an example and is not intended to limit the number of conference room terminals 10 and the like. In the following description, in a case where there is no particular reason to distinguish the conference room terminals 10-1 to 10-8, they are simply referred to as “conference room terminals 10”.

Each of the plurality of conference room terminals 10 and the server device 20 are connected via wired or wireless communication means, and are configured to be able to communicate with each other. The server device 20 may be installed in the same room or building as the conference room, or may be installed on a network (on a cloud).

The conference room terminal 10 is a terminal installed in each seat of the conference room. The participant operates the terminal to perform the conference while displaying necessary information and the like. The conference room terminal 10 has a camera function and is configured to be able to image a participant who is seated. The conference room terminal 10 is configured to be connectable to a microphone (for example, a pin microphone or a wireless microphone). A voice of a participant seated in front of each of the conference room terminals 10 is collected by the microphone. The microphone connected to the conference room terminal 10 is desirably a microphone with strong directivity. This is because it is only necessary to collect a voice of a user wearing the microphone, and it is not necessary to collect a voice of another person.

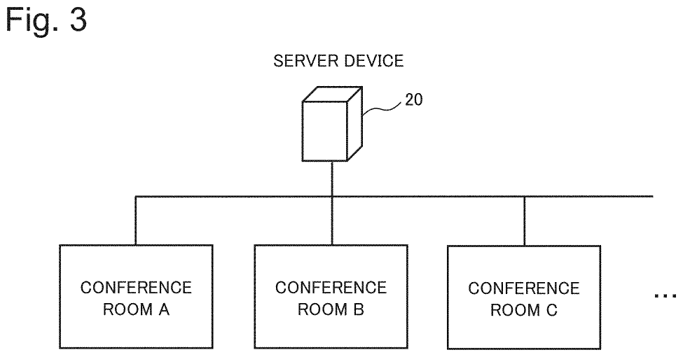

The server device 20 is a device that assists with a conference. The server device 20 assists with a conference that is a place for decision making and a place for idea generation. The server device 20 collects voices of participants and extracts a keyword included in the collected statements. The server device 20 stores the participants and the keyword uttered by the participants in association with each other, and generates simplified minutes of the conference in real time. The server device 20 supports a conference held in at least one or more conference rooms as illustrated in FIG. 3.

The server device 20 generates the minutes and also analyzes the generated minutes. The server device 20 analyzes the minutes to extract a keyword indicating a state of discussion in the conference. For example, the server device 20 extracts a keyword briefly indicating a discussion currently in progress or a keyword indicating directionality of the entire conference.

In the following description, a keyword indicating a state of a discussion in a conference will be referred to as a “conference state word”. A keyword indicating a discussion currently in progress will be referred to as a “word of interest”. A keyword indicating the directionality of the entire conference will be referred to as a “global word”. The conference state word may be regarded as a keyword representing a discussion in a conference, the word of interest may be regarded as a keyword representing a discussion in a short period of time, and the global word may be regarded as a keyword representing a discussion in the entire conference.

For example, a case where a purpose of the conference is “discussion about the latest technical trend” is considered. In this case, for example, a discussion about “artificial intelligence (AI)” is performed. During the discussion, an intellectual property strategy and the like related to AI technology may be discussed. In this case, a keyword such as “AI” is uttered throughout the conference, but a keyword such as “patent” is uttered intensively while the intellectual property strategy is being discussed.

The server device 20 extracts a keyword intensively uttered in the entire conference such as “patent” as a “word of interest”. The server device 20 extracts a keyword uttered evenly in the entire conference, such as “AI”, as a “global word”.

The server device 20 provides the conference state words (the word of interest and the global word) to participants in the conference. Specifically, the server device 20 transmits the word of interest and/or the global word to the conference room terminal 10 used by each participant. The participants who come in contact with the word of interest can accurately ascertain the content (topic) currently being discussed. The participants who come in contact with the global word will refrain from making statements that greatly deviate from the major purpose of the conference (the purpose of the conference).

For example, in the above example, the participants recognize that the topic currently discussed is the “intellectual property strategy”, and actively discuss patent applications and the like. Since the participants can also recognize that the content of the technology being discussed throughout the conference is “AI”, the participants do not discuss patent applications for other technologies (for example, a quantum computer) during the discussion about the intellectual property strategy. The participants can easily lead the conclusion of the conference or the like by coming in contact with the keywords (the word of interest and the global word) as described above at the end of the conference.

<Advance Preparation>

Here, in order to enable conference assistance by the server device 20, a system user (a user scheduled to participate in the conference) needs to make an advance preparation. The advance preparation will be described below.

A user registers attribute values such as his/her biological information and profile in the system. Specifically, the user inputs a face image to the server device 20. The user inputs his/her profile (for example, information such as a name, an employee number, a place of work, a department to which the employee belongs, a position, and a contact information) to the server device 20.

Any method may be used to input information such as the biological information and the profile. For example, the user captures his/her face image by using a terminal such as a smartphone. The user generates a text file or the like in which the profile is written by using the terminal. The user operates the terminal to transmit the information (the face image and the profile) to the server device 20. Alternatively, the user may input necessary information to the server device 20 by using an external storage device such as a Universal Serial Bus (USB) in which the information is stored.

Alternatively, the server device 20 may function as a Web server, and the user may input necessary information by using a form provided by the server. Alternatively, a terminal for inputting the information may be installed in each conference room, and the user may input necessary information to the server device 20 from the terminal installed in the conference room.

The server device 20 updates a database that manages system users by using the acquired user information (the biological information, the profiles, and the like). Details regarding update of the database will be described later, but the server device 20 roughly updates the database according to the following operation. In the following description, a database for managing users using the system of the present disclosure will be referred to as a “user database”.

In a case where a person relevant to the acquired user information is a new user not registered in the user database, the server device 20 assigns an identifier (ID) to the user. The server device 20 generates feature value that characterizes the acquired face image.

The server device 20 adds an entry including the ID assigned to the new user, the feature value generated from the face image, the face image of the user, the profile, and the like to the user database. When the server device 20 registers the user information, a participant in the conference can use the conference assistance system illustrated in FIG. 2.

Next, details of each device included in the conference assistance system according to the first example embodiment will be described.

[Server Device]

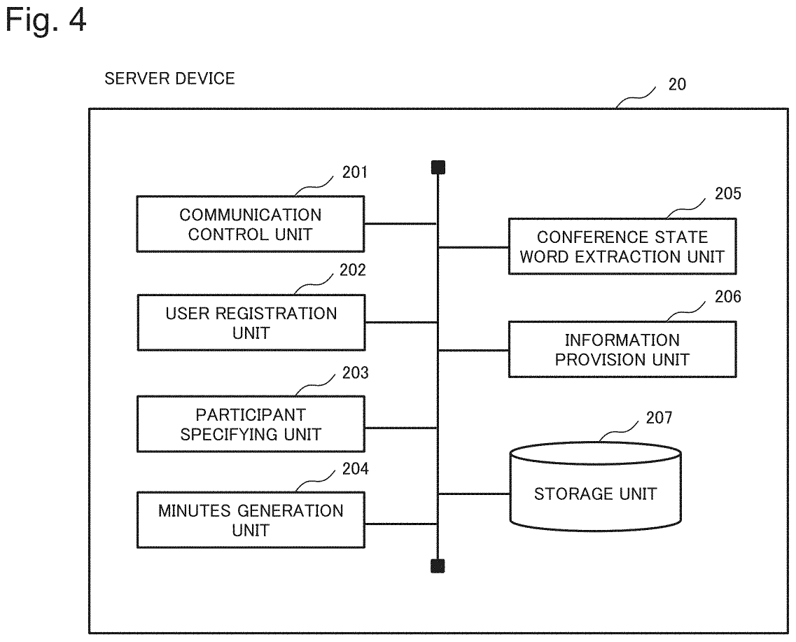

FIG. 4 is a diagram illustrating an example of a processing configuration (processing module) of the server device 20 according to the first example embodiment. Referring to FIG. 4, the server device 20 includes a communication control unit 201, a user registration unit 202, a participant specifying unit 203, a minutes generation unit 204, a conference state word extraction unit 205, an information provision unit 206, and a storage unit 207.

The communication control unit 201 is a unit that controls communication with other devices. Specifically, the communication control unit 201 receives data (packets) from the conference room terminal 10. The communication control unit 201 transmits data to the conference room terminal 10. The communication control unit 201 delivers data received from another device to another processing module. The communication control unit 201 transmits data acquired from the another processing module to the another device. As described above, the another processing module transmits and receives data to and from the another device via the communication control unit 201.

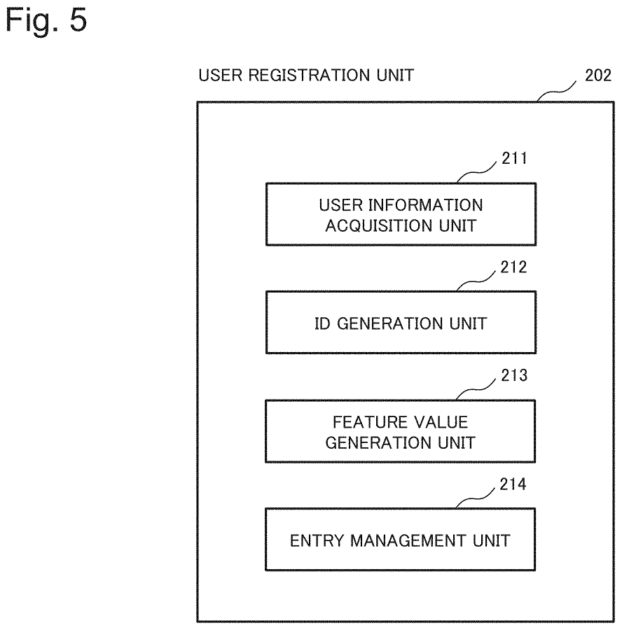

The user registration unit 202 is a unit that enables the system user registration described above. The user registration unit 202 includes a plurality of submodules. FIG. 5 is a diagram illustrating an example of a processing configuration of the user registration unit 202. Referring to FIG. 5, the user registration unit 202 includes a user information acquisition unit 211, an ID generation unit 212, a feature value generation unit 213, and an entry management unit 214.

The user information acquisition unit 211 is a unit that acquires the user information described above. The user information acquisition unit 211 acquires biological information (face image) and a profile (a name, an affiliation, and the like) of the system user. The system user may input the information from his/her terminal to the server device 20, or may directly operate the server device 20 to input the information.

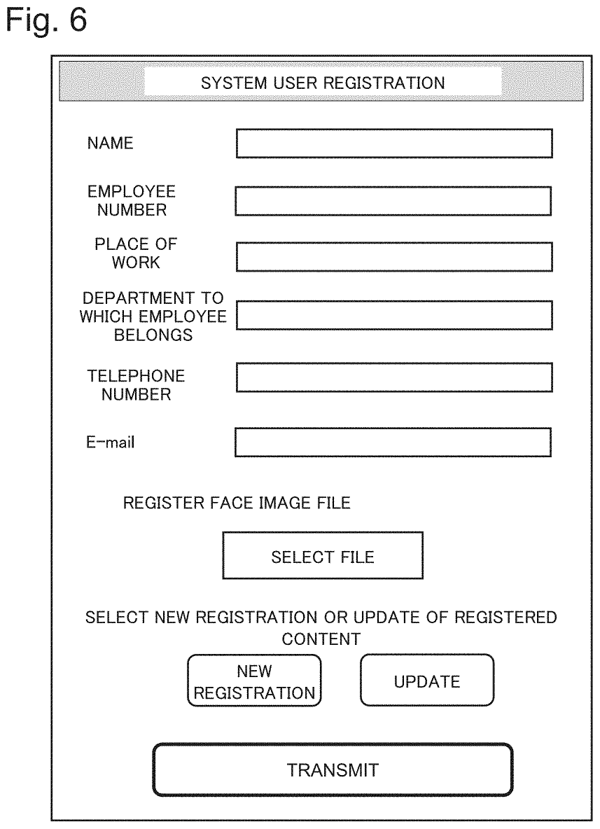

The user information acquisition unit 211 may provide a graphical user interface (GUI) or a form for inputting the information. For example, the user information acquisition unit 211 displays an information input form as illustrated in FIG. 6 on the terminal operated by the user.

The system user inputs the information illustrated in FIG. 6. The system user selects whether to newly register the user in the system or to update the already registered information. After inputting all the information, the system user presses a “transmit” button, and inputs the biological information and the profile to the server device 20.

The user information acquisition unit 211 stores the acquired user information in the storage unit 207.

The ID generation unit 212 is a unit that generates an ID to be assigned to the system user. In a case where the user information input by the system user is information related to new registration, the ID generation unit 212 generates an ID for identifying the new user. For example, the ID generation unit 212 may calculate a hash value of the acquired user information (the face image and the profile) and use the hash value as an ID to be assigned to the user. Alternatively, the ID generation unit 212 may assign a unique value each time user registration is performed and use the assigned value as an ID. In the following description, an ID (an ID for identifying a system user) generated by the ID generation unit 212 will be referred to as a “user ID”.

The feature value generation unit 213 is a unit that generates feature value (a feature vector including a plurality of feature values) characterizing the face image from the face image included in the user information. Specifically, the feature value generation unit 213 extracts feature points from the acquired face image. An existing technique may be used for the feature point extraction process, and thus a detailed description thereof will be omitted. For example, the feature value generation unit 213 extracts eyes, a nose, a mouth, and the like as feature points from the face image. Thereafter, the feature value generation unit 213 calculates a position of each feature point or a distance between the feature points as a feature value, and generates a feature vector (vector information characterizing the face image) including a plurality of feature values.

The entry management unit 214 is a unit that manages an entry of the user database. Upon registering a new user in the database, the entry management unit 214 adds an entry including the user ID generated by the ID generation unit 212, the feature value generated by the feature value generation unit 213, the face image, and the profile acquired from the user to the user database.

Upon updating the information regarding the user already registered in the user database, the entry management unit 214 specifies an entry to be subjected to information update based on an employee number or the like, and updates the user database by using the acquired user information. In this case, the entry management unit 214 may update a difference between the acquired user information and the information registered in the database, or may overwrite each item of the database with the acquired user information. Similarly, regarding the feature value, the entry management unit 214 may update the database when there is a difference in the generated feature value, or may overwrite the existing feature value with the newly generated feature value.

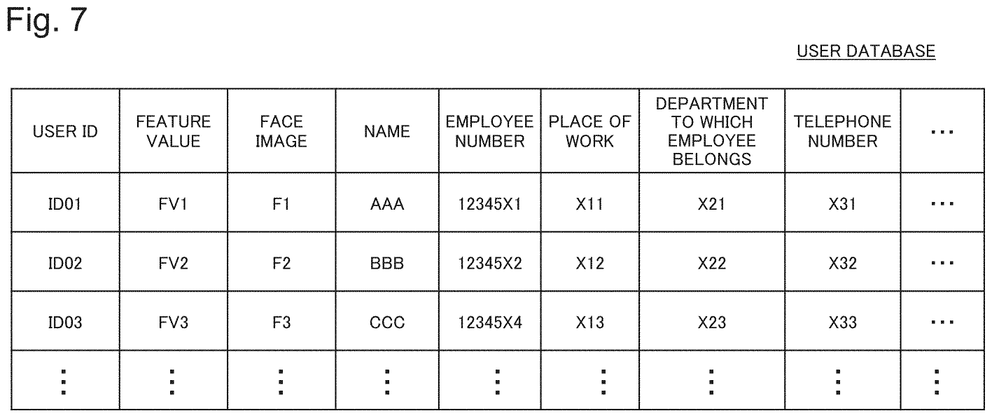

The user registration unit 202 operates to construct a user database as illustrated in FIG. 7. It goes without saying that contents registered in the user database illustrated in FIG. 7 are an example and are not intended to limit information registered in the user database. For example, the “face image” does not have to be registered in the user database as necessary.

The description returns to FIG. 4. The participant specifying unit 203 is a unit that specifies a participant participating in the conference (a user who has entered the conference room among users registered in the system). The participant specifying unit 203 acquires a face image from the conference room terminal 10 in front of a seat of the participant among the conference room terminals 10 installed in the conference room. The participant specifying unit 203 calculates a feature value from the acquired face image.

The participant specifying unit 203 sets a feature value calculated based on the face image acquired from the conference room terminal 10 as a collation target, and performs a collation process with a feature value registered in the user database. More specifically, the participant specifying unit 203 sets the calculated feature value (feature vector) as a collation target, and executes one-to-N (where N is a positive integer, and the same applies hereinafter) collation with a plurality of feature vectors registered in the user database.

The participant specifying unit 203 calculates a similarity between the feature value that is a collation target and each of the plurality of feature values on the registration side. A chi-square distance, a Euclidean distance, or the like may be used as the similarity. The similarity is lower as the distance is longer, and the similarity is higher as the distance is shorter.

The participant specifying unit 203 specifies a feature value having a similarity with the feature value that is a collation target equal to or more than a predetermined value and having the highest similarity among the plurality of feature values registered in the user database.

The participant specifying unit 203 reads the user ID relevant to the feature value obtained as a result of the one-to-N collation from the user database.

The participant specifying unit 203 repeatedly performs the above process on a face image acquired from each of the conference room terminals 10, and specifies a user ID relevant to each face image. The participant specifying unit 203 generates a participant list by associating the specified user ID with the ID of the conference room terminal 10 that is a transmission source of the face image. As the ID of the conference room terminal 10, a Media Access Control (MAC) address or an Internet Protocol (IP) address of the conference room terminal 10 may be used.

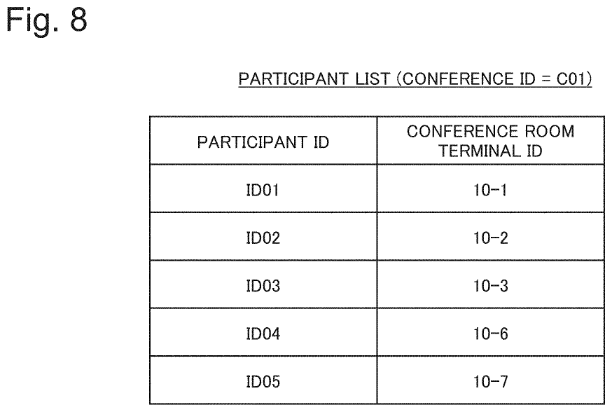

For example, in the example in FIG. 2, a participant list as illustrated in FIG. 8 is generated. In FIG. 8, for better understanding, reference numerals assigned to the conference room terminals 10 are described as conference room terminal IDs. The “participant ID” included in the participant list is a user ID registered in the user database.

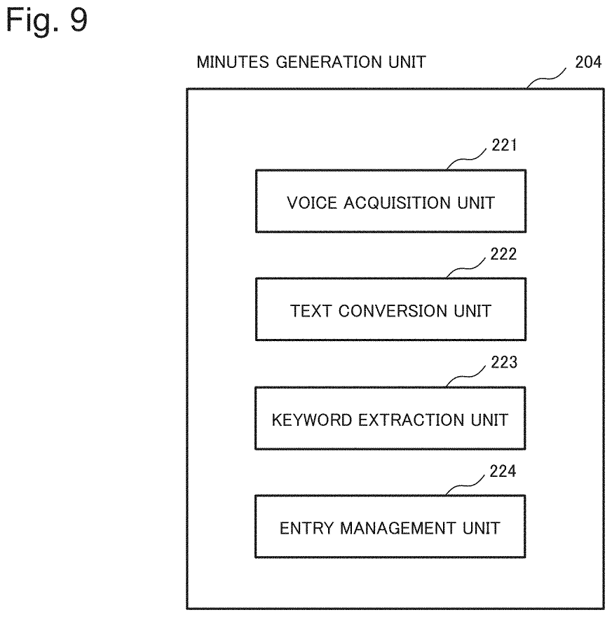

The minutes generation unit 204 is a unit that collects voices of participants and generates minutes (simplified minutes) of a conference. The minutes generation unit 204 includes a plurality of submodules. FIG. 9 is a diagram illustrating an example of a processing configuration of the minutes generation unit 204. Referring to FIG. 9, the minutes generation unit 204 includes a voice acquisition unit 221, a text conversion unit 222, a keyword extraction unit 223, and an entry management unit 224.

The voice acquisition unit 221 is a unit that acquires a voice of a participant from the conference room terminal 10. The conference room terminal 10 generates an audio file each time a participant makes a statement, and transmits the audio file to the server device 20 together with an ID (conference room terminal ID) of the own device. The voice acquisition unit 221 refers to the participant list and specifies a participant ID relevant to the acquired conference room terminal ID. The voice acquisition unit 221 delivers the specified participant ID and the audio file acquired from the conference room terminal 10 to the text conversion unit 222.

The text conversion unit 222 converts the acquired audio file into text. The text conversion unit 222 converts the content recorded in the audio file into text by using a voice recognition technique. Since the text conversion unit 222 can use an existing voice recognition technique, detailed description thereof is omitted, but the text conversion unit operates as follows.

The text conversion unit 222 performs filter processing for removing noise and the like from the audio file. Next, the text conversion unit 222 specifies phonemes from sound waves of the audio file. A phoneme is the smallest constituent unit of a language. The text conversion unit 222 specifies a sequence of phonemes and converts the sequence into a word. The text conversion unit 222 creates a sentence from a sequence of words and outputs a text file. At the time of the filter processing, since a voice less than a predetermined level is deleted, even when neighboring sound is included in the audio file, the text file is not generated from the neighboring sound.

The text conversion unit 222 delivers the participant ID and the text file to the keyword extraction unit 223.

The keyword extraction unit 223 is a unit that extracts a keyword from a text file. For example, the keyword extraction unit 223 refers to an extraction keyword list in which keywords to be extracted are written in advance, and extracts a keyword written in the list from the text file. Alternatively, the keyword extraction unit 223 may extract a noun included in the text file as a keyword.

For example, a case where a participant makes a statement that “AI is becoming more and more important technology” is considered. In this case, if the word “AI” is registered in the extraction keyword list, “AI” is extracted from the above statement. Alternatively, in a case where a noun is extracted, “AI” and “technology” are extracted. An existing part-of-speech decomposition tool (application) or the like may be used to extract nouns.

The keyword extraction unit 223 delivers the participant ID and the extracted keyword to the entry management unit 224.

The minutes generation unit 204 generates minutes (minutes in which at least a speaker (participant ID) and statement content (keyword) are included in one entry) in a table format.

The entry management unit 224 is a unit that manages entries of the minutes. The entry management unit 224 generates minutes for each conference being held. Upon detecting the start of the conference, the entry management unit 224 generates new minutes. For example, the entry management unit 224 may detect the start of the conference by acquiring an explicit notification of the start of the conference from the participant, or may detect the start of the conference when the participant makes a statement for the first time.

Upon detecting the start of the conference, the entry management unit 224 generates an ID (hereinafter, referred to as a conference ID) for identifying the conference, and associates the ID with the minutes. The entry management unit 224 may generate the conference ID by using a number of the conference room, the holding date and time of the conference, and the like. Specifically, the entry management unit 224 may generate the conference ID by concatenating the above information and calculating a hash value. The entry management unit 224 can know a number of the conference room by referring to table information or the like in which a conference room terminal ID and a of the conference room are associated with each other. The entry management unit 224 can know the “holding date and time of the conference” from the date and time of the start of the conference and the time. The entry management unit 224 associates the generated conference ID with the participant list.

The entry management unit 224 adds the statement time, the participant ID, and the extracted keyword to the minutes in association with each other. The statement time may be a time managed by the server device 20 or a time at which a voice is acquired from the conference room terminal 10.

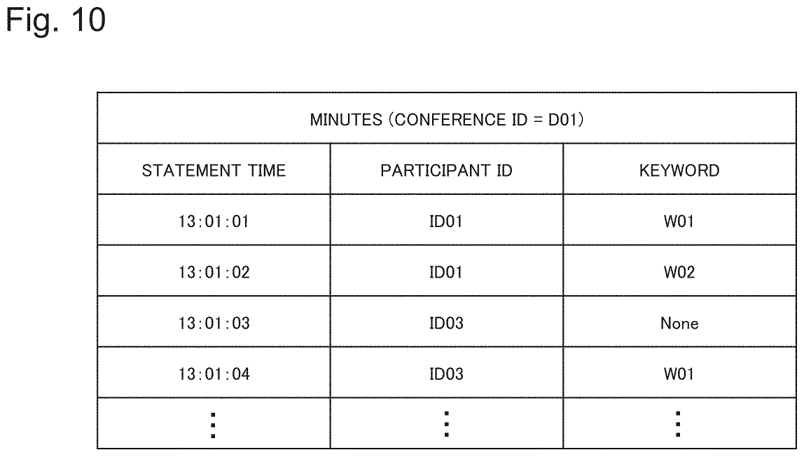

FIG. 10 is a diagram illustrating an example of minutes. As illustrated in FIG. 10, the entry management unit 224 adds a keyword uttered by the participant to the minutes together with the participant ID each time a voice of the participant is acquired. In a case where a keyword cannot be extracted from the statement of the participant, the entry management unit 224 clearly indicates the absence of the keyword by setting “None” or the like in the field of the keyword. Alternatively, in a case where a plurality of keywords are found in one statement, the entry management unit 224 may divide an entry to be registered, or may write a plurality of keywords in one entry.

The generation of the minutes by the minutes generation unit 204 is an example and is not intended to limit a method of generating minutes or generated minutes. For example, the minutes generation unit 204 may generate, as minutes, information in which a speaker is associated with statement content (a text file corresponding to the statement).

The description returns to FIG. 4. The conference state word extraction unit 205 is a unit that analyzes the minutes generated from statements of participants and extracts a keyword (conference state word) indicating a state of the conference. More specifically, the conference state word extraction unit 205 extracts (determines or generates) at least one of the word of interest and the global word described above from the generated minutes.

More specifically, the conference state word extraction unit 205 extracts a keyword (word) having the largest number of times of utterance among keywords uttered during a period from the present time to a predetermined time ago (predetermined period) as a “word of interest”. For example, the conference state word extraction unit 205 extracts a keyword having the largest number of times of utterance among keywords uttered during the last 5 minutes as a word of interest.

The conference state word extraction unit 205 extracts a keyword having the largest number of times of utterance among keywords uttered throughout the entire conference (from the start of the conference to the present time or from the start of the conference to the analysis of the minutes) as a “global word”.

The conference state word extraction unit 205 executes a conference state word extraction process periodically or at a predetermined timing. The conference state word extraction unit 205 may execute the conference state word extraction process according to an explicit instruction from a participant. The conference state word extraction unit 205 delivers the extracted conference state words (the word of interest and the global word) to the information provision unit 206.

The information provision unit 206 is a unit that provides information to participants in the conference. The information provision unit 206 generates information (hereinafter, referred to as conference information.) regarding a state of the discussion in the conference based on the conference state words (the word of interest and the global word) acquired from the conference state word extraction unit 205. The information provision unit 206 transmits the generated conference information to the conference room terminal 10.

The information provision unit 206 transmits the generated conference information to the conference room terminal 10 periodically or at a predetermined timing. For example, the information provision unit 206 transmits the conference information to the conference room terminal 10 at a timing at which a new conference state word is extracted or at a timing at which the conference state word is updated.

The information provision unit 206 may transmit the generated latest conference state words (the word of interest and the global word) to the conference room terminal 10 as conference information without any change. Alternatively, the information provision unit 206 may also generate and transmit conference information by using conference state words (the word of interest and the global word) generated in the past. For example, the information provision unit 206 may generate conference information including a change history of a word of interest (history related to transition of the word of interest).

In a case where a request for provision of conference information is acquired from the conference room terminal 10, the information provision unit 206 generates conference information according to the request and transmits the conference information to the conference room terminal 10 that is a request source. For example, in a case where a request for provision of a word of interest is received from the conference room terminal 10, the information provision unit 206 returns the latest word of interest to the conference room terminal 10. Alternatively, in a case where a request for provision of a history of a word of interest is received from the conference room terminal 10, the information provision unit 206 generates time-series data (history) related to the word of interest from the beginning of the conference to the request acquisition time point, and returns the data to the conference room terminal 10. In a case where a request for provision of a global word is received, the information provision unit 206 transmits conference information including the global word to the conference room terminal 10.

The storage unit 207 is a unit that stores information necessary for an operation of the server device 20.

[Conference Room Terminal]

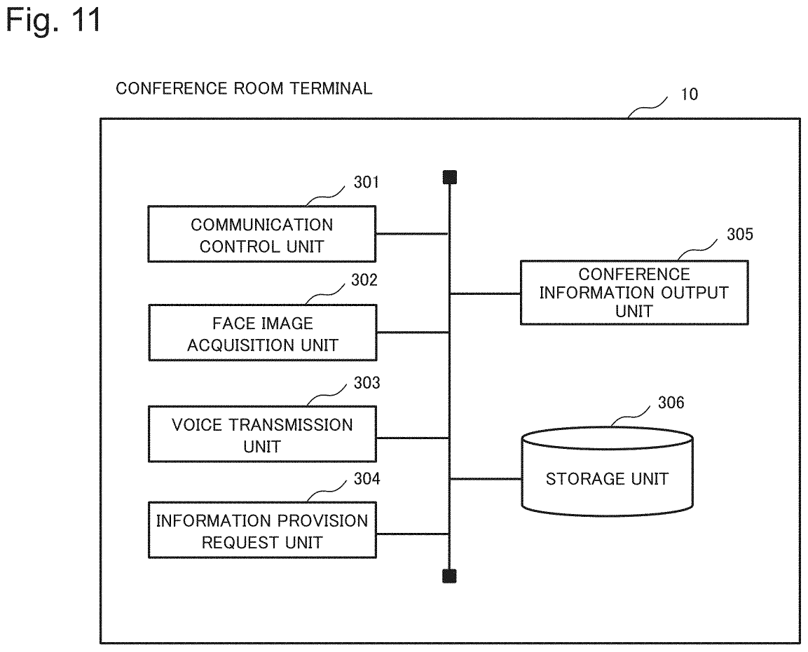

FIG. 11 is a diagram illustrating an example of a processing configuration (processing module) of the conference room terminal 10. Referring to FIG. 11, the conference room terminal 10 includes a communication control unit 301, a face image acquisition unit 302, a voice transmission unit 303, an information provision request unit 304, a conference information output unit 305, and a storage unit 306.

The communication control unit 301 is a unit that controls communication with other devices. Specifically, the communication control unit 301 receives data (packets) from the server device 20. The communication control unit 301 transmits data to the server device 20. The communication control unit 301 delivers data received from another device to another processing module. The communication control unit 301 transmits data acquired from the another processing module to the another device. As described above, the another processing module transmits and receives data to and from the another device via the communication control unit 301.

The face image acquisition unit 302 is a unit that controls a camera device and acquires a face image (biological information) of a participant seated in front of the own device. The face image acquisition unit 302 images the front of the own device periodically or at a predetermined timing. The face image acquisition unit 302 determines whether a face image of a person is included in the acquired image, and extracts the face image from the acquired image data in a case where the face image is included. The face image acquisition unit 302 transmits a set including the extracted face image and the ID (conference room terminal ID; for example, an IP address) of the own device to the server device 20.

Since an existing technique can be used for a face image detection process or a face image extraction process by the face image acquisition unit 302, detailed description thereof will be omitted. For example, the face image acquisition unit 302 may extract a face image (face region) from image data by using a learning model learned by a convolutional neural network (CNN). Alternatively, the face image acquisition unit 302 may extract the face image by using a method such as template matching.

The voice transmission unit 303 is a unit that acquires a voice of a participant and transmits the acquired voice to the server device 20. The voice transmission unit 303 acquires an audio file related to voices collected by a microphone (for example, a pin microphone). For example, the voice transmission unit 303 acquires an audio file encoded in a format such as a WAV file (Waveform Audio File).

The voice transmission unit 303 analyzes the acquired audio file, and in a case where an audio section (a section other than silence; a statement of the participant) is included in the audio file, transmits the audio file including the audio section to the server device 20. In this case, the voice transmission unit 303 transmits the audio file and the ID (conference room terminal ID) of the own device to the server device 20.

Alternatively, the voice transmission unit 303 may attach the conference room terminal ID to the audio file acquired from the microphone and transmit the audio file to the server device 20 without any change. In this case, the audio file acquired by the server device 20 may be analyzed to extract the audio file including the voice.

The voice transmission unit 303 extracts an audio file (a non-silent audio file) including the statement of the participant by using the existing “voice detection technique”. For example, the voice transmission unit 303 detects a voice by using a voice parameter sequence or the like modeled by a hidden Markov model (HMM).

The information provision request unit 304 is a unit that requests the server device 20 to provide the above-described “conference information” according to an operation of the participant.

For example, in a case where the participant desires to know or confirm a topic in the discussion currently in progress, the participant inputs, to the conference room terminal 10, a request for provision of information regarding a word of interest to the server device 20. Alternatively, the participant inputs, to the conference room terminal 10, a request for provision of information regarding a history of a word of interest to the server device 20 in order to know what kind of agenda has been handled through the conference. Alternatively, in a case where the participant desires to know a global flow of the conference and the agenda, the participant inputs, to the conference room terminal 10, a request for provision of information regarding a global word to the server device 20.

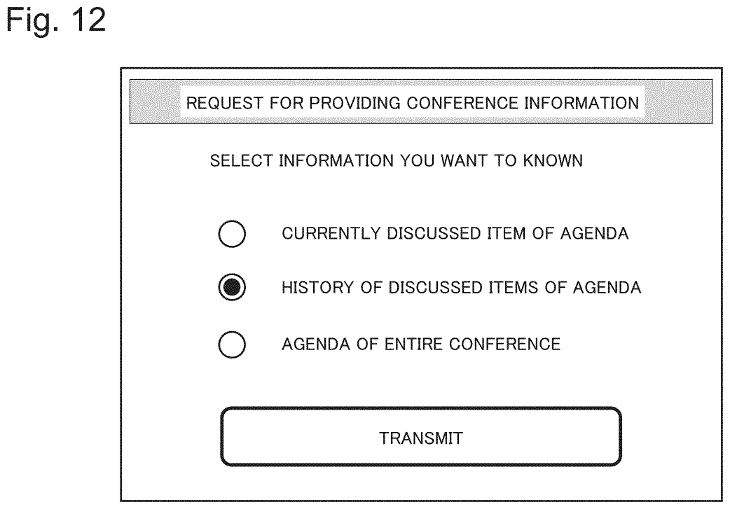

For example, the information provision request unit 304 generates a GUI for inputting conference information that the participant desires to know. For example, the information provision request unit 304 displays a screen as illustrated in FIG. 12 on the display. Options illustrated in FIG. 12 are associated to provision of information regarding a word of interest, provision of information regarding a history of the word of interest, and provision of information regarding a global word from the top.

The information provision request unit 304 transmits an information provision request corresponding to the request from the participant acquired via the GUI to the server device 20. That is, the information provision request unit 304 transmits an information provision request corresponding to an input operation of the participant to the server device 20.

The information provision request unit 304 acquires a response to the request from the server device 20. The information provision request unit 304 delivers the acquired response to the conference information output unit 305.

The conference information output unit 305 is a unit that outputs the conference information acquired from the server device 20.

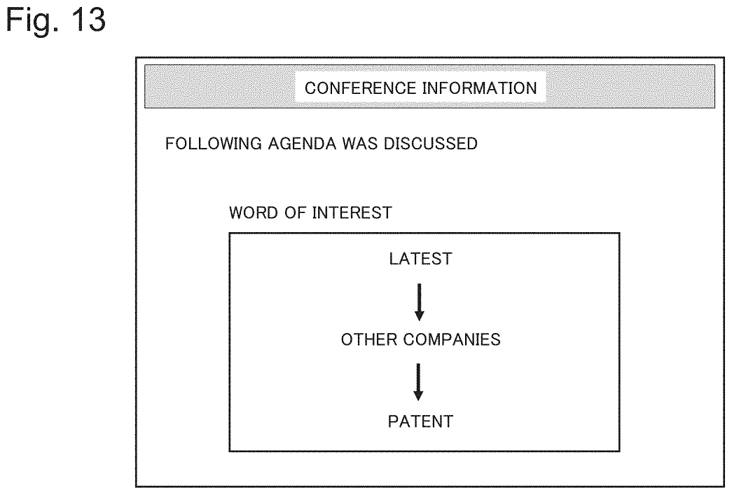

For example, the conference information output unit 305 displays a screen as illustrated in FIG. 13 on the display.

FIG. 13 illustrates an example of screen display in a case where information regarding a history of a word of interest is acquired. In a case where a subject of the conference is “AI”, a participant who has contact with the conference information as illustrated in FIG. 13 can ascertain that the latest technology of AI has been discussed, then statuses of other companies have been discussed, and then patent application has been discussed.

The display illustrated in FIG. 13 is an example and is not intended to limit output content of the conference information output unit 305. The conference information output unit 305 may print the conference information, or may transmit the conference information to a predetermined e-mail address or the like.

As described above, the server device 20 may transmit the conference information to the conference room terminal 10 periodically or at a predetermined timing. The conference information output unit 305 may display the entire screen separately into an area for displaying the conference information acquired according to the request of the participant and an area for displaying the conference information periodically transmitted from the server device 20. In this case, the conference information output unit 305 updates the display of the relevant area based on the conference information transmitted periodically.

The storage unit 306 is a unit that stores information necessary for an operation of the conference room terminal 10.

[Operation of Conference Assistance System]

Next, an operation of the conference assistance system according to the first example embodiment will be described.

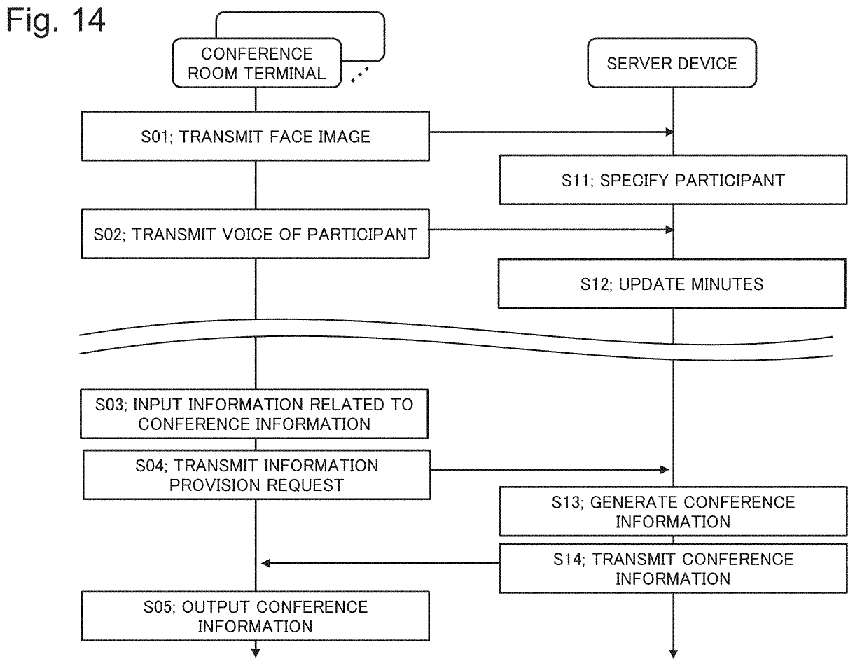

FIG. 14 is a sequence diagram illustrating an example of an operation of the conference assistance system according to the first example embodiment. FIG. 14 is a sequence diagram illustrating an example of a system operation when a conference is actually held. It is assumed that a system user is registered in advance prior to the operation in FIG. 14.

When the conference is started and participants are seated, the conference room terminal 10 acquires a face image of the seated participant and transmits the face image to the server device 20 (step S01).

The server device 20 specifies the participant by using the acquired face image (step S11). The server device 20 sets a feature value calculated from the acquired face image as a feature value on a collation side and sets the plurality of feature values registered in the user database as feature values on a registration side, and executes one-to-N (where N is a positive integer, and the same applies hereinafter) collation. The server device 20 repeats the collation for each participant (the conference room terminal 10 used by the participant) in the conference and generates a participant list.

The conference room terminal 10 acquires voices of the participants and transmits the voices to the server device 20 (step S02). That is, the voices of the participant are collected by the conference room terminal 10 and sequentially transmitted to the server device 20.

The server device 20 analyzes the acquired voice (audio file) and extracts a keyword from a statement of the participant. The server device 20 updates the minutes by using the extracted keyword and a participant ID (step S12).

While the conference is being held, the processes in steps S02 and S12 are repeatedly performed. As a result, a speaker and a main point (keyword) of the statement of the speaker are added to the minutes (simplified minutes in a table format).

In a case where the participant desires to know transition of the discussion in the conference, the participant performs an input operation related to conference information desired to be known (step S03). That is, the conference room terminal 10 inputs information related to conference information from the participant.

The conference room terminal 10 transmits an information provision request corresponding to the acquired input to the server device 20 (step S04).

The server device 20 generates conference information corresponding to the acquired information provision request (step S13).

The server device 20 transmits a response (a response to the information provision request) including the generated conference information to the conference room terminal 10 (step S14).

The conference room terminal 10 outputs the acquired response (conference information) (step S05).

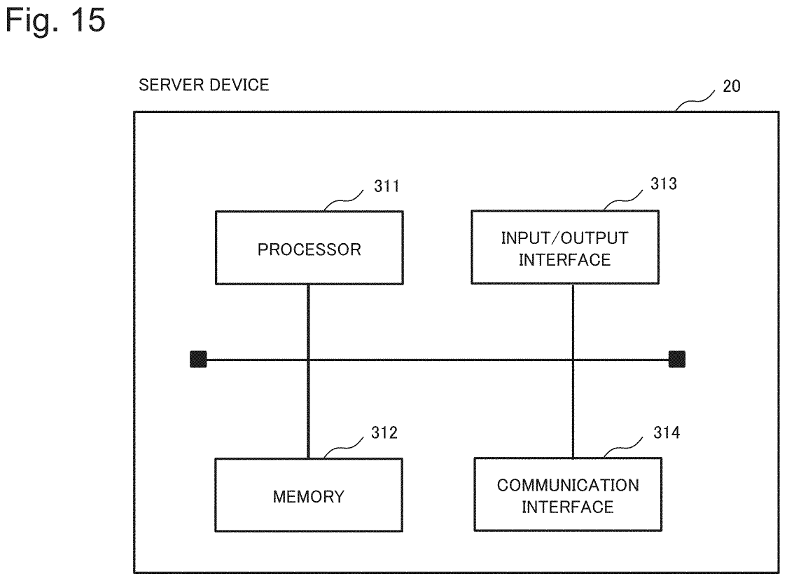

Next, hardware of each device configuring the conference assistance system will be described. FIG. 15 is a diagram illustrating an example of a hardware configuration of the server device 20.

The server device 20 may be configured by an information processing device (so-called computer), and has a configuration exemplified in FIG. 15. For example, the server device 20 includes a processor 311, a memory 312, an input/output interface 313, a communication interface 314, and the like. The constituents such as the processor 311 are connected to each other via an internal bus or the like, and are configured to be able to communicate with each other.

However, the configuration illustrated in FIG. 15 is not intended to limit a hardware configuration of the server device 20. The server device 20 may include hardware (not illustrated) or may not include the input/output interface 313 as necessary. The number of processors 311 and the like included in the server device 20 is not limited to the example in FIG. 15, and for example, a plurality of processors 311 may be included in the server device 20.

The processor 311 is a programmable device such as a central processing unit (CPU), a micro processing unit (MPU), or a digital signal processor (DSP). Alternatively, the processor 311 may be a device such as a field programmable gate array (FPGA) or an application specific integrated circuit (ASIC). The processor 311 is configured to execute various programs including an operating system (OS).

The memory 312 is a random access memory (RAM), a read only memory (ROM), a hard disk drive (HDD), a solid state drive (SSD), or the like. The memory 312 stores an OS program, an application program, and various data.

The input/output interface 313 is an interface of a display device or an input device (not illustrated). The display device is, for example, a liquid crystal display. The input device is a device such as a keyboard or a mouse that receives a user operation.

The communication interface 314 is a circuit, a module, or the like that communicates with another device. For example, the communication interface 314 includes a network interface card (NIC) or the like.

The functions of the server device 20 are achieved by various processing modules. The processing module is achieved, for example, by the processor 311 executing a program stored in the memory 312. The program may be recorded in a computer-readable storage medium. The storage medium may be a non-transient (non-transitory) medium such as a semiconductor memory, a hard disk, a magnetic recording medium, or an optical recording medium. That is, the present invention can also be embodied as a computer program product. The program may be downloaded via a network or updated by using a storage medium storing the program. The processing module may be achieved by a semiconductor chip.

The conference room terminal 10 can also be configured by an information processing device similarly to the server device 20, and since there is no difference in a basic hardware configuration from the server device 20, the description thereof will be omitted. The conference room terminal 10 may include a camera and a microphone, or may be configured to be connectable to a camera and a microphone.

As described above, the server device 20 according to the first example embodiment generates minutes of a conference. The server device 20 analyzes the generated minutes to generate conference information regarding a state of a discussion in the conference. For example, the server device 20 extracts a keyword intensively uttered locally (partially) in the conference as a word of interest. Alternatively, the server device 20 extracts a keyword uttered evenly throughout (entire) the conference as a global word. The server device 20 generates conference information based on these keywords and provides the conference information to participants. The participants can accurately recognize (ascertain) the currently discussed topic or a topic discussed in the entire conference based on the conference information.

### Modification Example

The configuration, operation, and the like of the conference assistance system described in the above example embodiment are merely examples, and are not intended to limit the configuration and the like of the system.

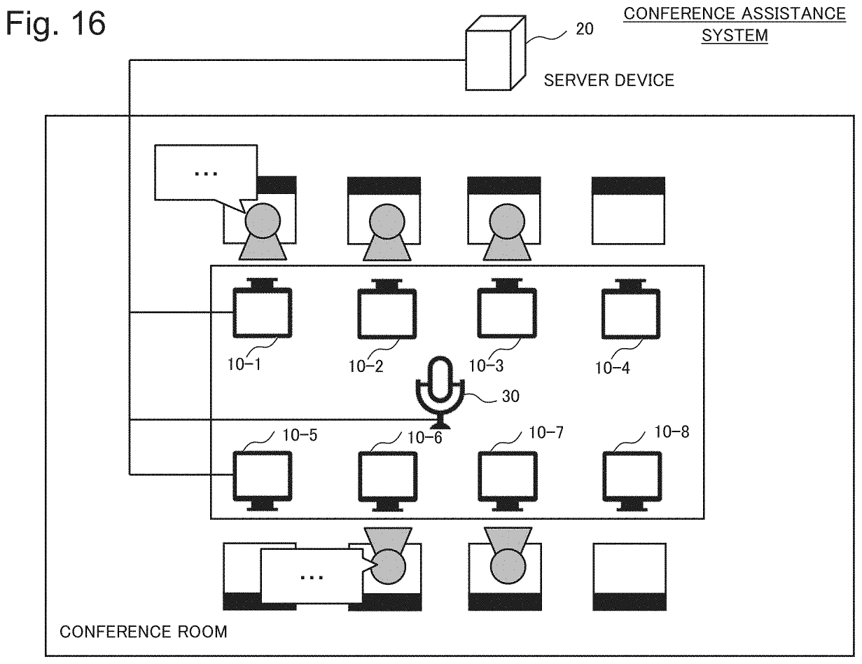

In the above example embodiment, a speaker in a conference is specified by generating the participant list. However, in the present disclosure, a speaker does not have to be specified. That is, as illustrated in FIG. 16, a single sound collecting microphone 30 may be installed on a desk, and the server device 20 may collect a statement of each participant via the sound collecting microphone 30.

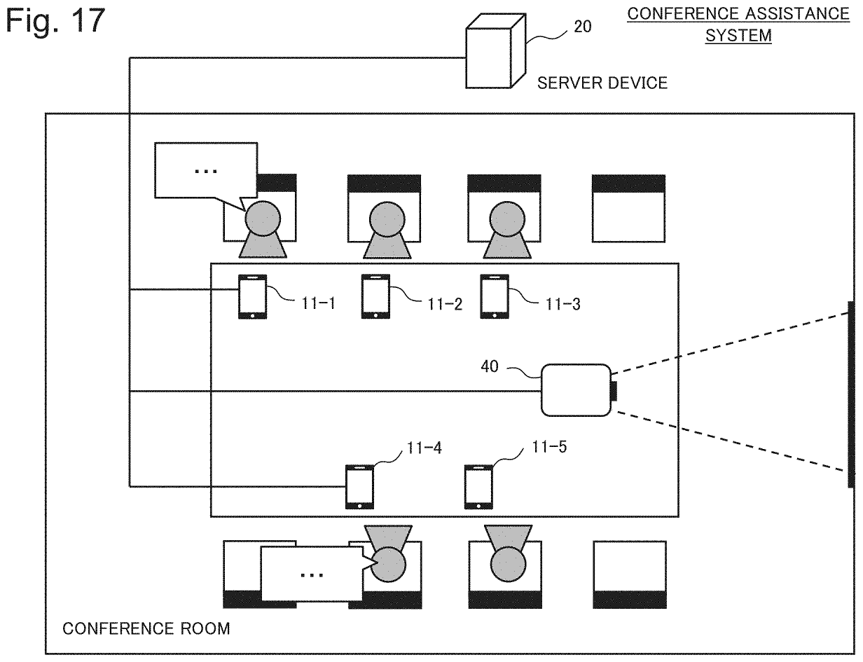

In the above example embodiment, the case where the dedicated conference room terminal 10 is installed on the desk has been described, but the function of the conference room terminal 10 may be achieved by a terminal possessed (owned) by the participant. For example, as shown in FIG. 17, participants may participate in the conference by using terminals 11-1 to 11-5. The participant operates his/her terminal 11 and transmits his/her face image to the server device 20 at the start of the conference. The terminal 11 transmits a voice of the participant to the server device 20. The server device 20 may provide an image, a video, or the like to the participant by using a projector 40.

A profile of a system user (an attribute value of the user) may be input by using a scanner or the like. For example, the user inputs an image related to his/her business card to the server device 20 by using a scanner. The server device 20 executes an optical character recognition (OCR) process on the acquired image. The server device 20 may determine a profile of the user based on the obtained information.

In the above example embodiment, the case where biological information related to a “face image” is transmitted from the conference room terminal 10 to the server device 20 has been described. However, biological information related to “a feature value generated from the face image” may be transmitted from the conference room terminal 10 to the server device 20. The server device 20 may execute a collation process with a feature value registered in the user database by using the acquired feature value (feature vector).

In the above example embodiment, a case where one word of interest and one global word are provided to the conference room terminal 10 as conference information has been described. However, the server device 20 may set a keyword uttered a predetermined number of times or more as a word of interest or a global word by executing threshold processing on extracted keywords.

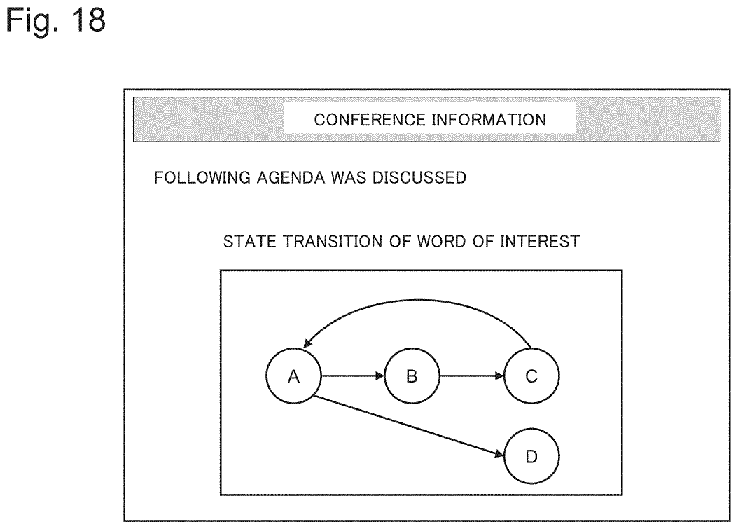

Upon outputting history information of a word of interest, the conference room terminal 10 may display state transition of each word of interest. For example, in a case where the word of interest transitions to A, B, C, A, and D, the conference room terminal 10 may perform display as illustrated in FIG. 18.

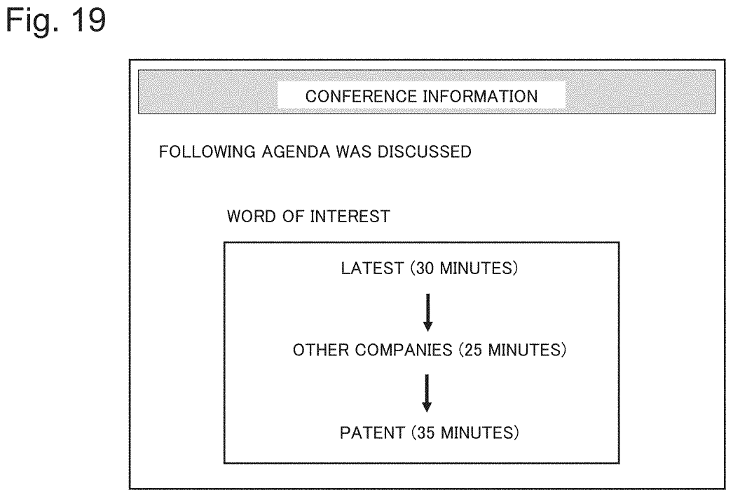

Alternatively, the server device 20 may calculate a time for which each word of interest is discussed and generate conference information including the calculated time. Specifically, the server device 20 calculates a time until a previously extracted word of interest is switched to another word of interest, and handles the calculated time as a discussion time of the previously extracted word of interest. The conference room terminal 10 that has acquired the conference information including the discussion time of each word of interest may display the discussion time together with display of the word of interest. In a case where the history of the word of interest is displayed, the conference room terminal 10 may display the word of interest together with the discussion time (refer to FIG. 19). Alternatively, the conference room terminal 10 may display a discussion time relevant to the state transition of the word of interest as illustrated in FIG. 18.

Alternatively, the server device 20 may generate conference information including the number of times of utterance of a word of interest or a global word. The conference room terminal 10 may also display the number of times of utterance together with the word of interest by using the conference information.

In the above example embodiment, the case where a word of interest (hot word) and a global word (major word) are extracted as conference state words has been described, but other words may be extracted as conference state words. For example, a keyword (a minor word or an overlooking word) that is uttered a small number of times in a conference may be extracted. When a participant operates the conference room terminal 10 to request the server device 20 to provide an overlooking word, the server device 20 generates a keyword (list of keywords) of which the number of times of utterance is below a predetermined number of times, and transmits the keyword to the conference room terminal 10 as conference information. A participant who has contact with such an overlooking word can discover an agenda or the like that has not been sufficiently discussed in the conference and perform further discussion. The server device 20 may automatically transmit an overlooking word (or a list of overlooking words) to the conference room terminal 10 when it is detected that the number of times of utterance (the number of utterances) of a participant in the conference decreases. The conference room terminal 10 may display the overlooking word (a list of overlooking words).

The server device 20 may consider an already generated (extracted) conference state word when conference information is generated. For example, upon determining a word of interest, the server device 20 may exclude the same keyword as a global word. This is because a global word is a keyword that is uttered evenly throughout the conference, and there is a probability that the number of times of utterance is larger than that of the word of interest that is intensively uttered in a short period of time. The server device 20 can prevent a situation in which a word of interest matches a global word by excluding the global word from the word of interest.

In the flow chart (the flowchart and the sequence diagram) used in the above description, a plurality of steps (processes) are described in order, but an execution order of the steps executed in the example embodiment is not limited to the described order. In the example embodiment, for example, the order of the illustrated steps can be changed within a range in which there is no problem in terms of content, such as executing a plurality of processes in parallel.

The above example embodiments have been described in detail for better understanding of the present disclosure, and it is not intended that all the configurations described above are necessary. In a case where a plurality of example embodiments have been described, each example embodiment may be used alone or in combination. For example, a part of the configuration of the example embodiment may be replaced with a configuration of another example embodiment, or the configuration of another example embodiment may be added to the configuration of the example embodiment. Addition, deletion, and replacement of other configurations may occur for a part of the configuration of the example embodiment.

Although the industrial applicability of the present invention is apparent from the above description, the present invention can be suitably applied to a system or the like that assists a conference or the like held by a company or the like.

The whole or part of the example embodiments disclosed above can be described as, but not limited to, the following supplementary notes.

### [Supplementary Note 1]

A server device including:

a generation unit that generates minutes of a conference from statements of participants;

an extraction unit that analyzes the generated minutes, thereby extracting a conference state word indicating a state of a discussion in a conference; and

a provision unit that generates conference information based on the conference state word and provides the generated conference information to a terminal.

### [Supplementary Note 2]

The server device according to Supplementary Note 1, in which the extraction unit analyzes the minutes, thereby extracting a global word indicating directionality of an entire meeting.

### [Supplementary Note 3]

The server device according to Supplementary Note 2, in which the extraction unit extracts, as the global word, a keyword having a largest number of times of utterance among keywords uttered during a period from start of the conference until the minutes are analyzed.

### [Supplementary Note 4]

The server device according to any one of Supplementary Notes 1 to 3, in which the extraction unit analyzes the minutes, thereby extracting a word of interest indicating a discussion in progress.

### [Supplementary Note 5]

The server device according to Supplementary Note 4, in which the extraction unit extracts, as the word of interest, a keyword having a largest number of times of utterance among keywords uttered during a predetermined period.

### [Supplementary Note 6]

The server device according to Supplementary Note 4 or 5, in which the provision unit generates the conference information including a history related to transition of the word of interest.

### [Supplementary Note 7]

A conference assistance system including:

a terminal that is used by a participant in a conference; and

a server device, in which

the server device includes:

a generation unit that generates minutes of the conference from statements of participants;

an extraction unit that analyzes the generated minutes, thereby extracting a conference state word indicating a state of a discussion in the conference; and

a provision unit that generates conference information based on the conference state word and provides the generated conference information to the terminal.

### [Supplementary Note 8]

The conference assistance system according to Supplementary Note 7, in which the extraction unit analyzes the minutes, thereby extracting a global word indicating directionality of an entire meeting.

### [Supplementary Note 9]

The conference assistance system according to Supplementary Note 8, in which the extraction unit extracts, as the global word, a keyword having a largest number of times of utterance among keywords uttered during a period from start of the conference until the minutes are analyzed.

### [Supplementary Note 10]

The conference assistance system according to any one of Supplementary Notes 7 to 9, in which the extraction unit analyzes the minutes, thereby extracting a word of interest indicating a discussion in progress.

### [Supplementary Note 11]

The conference assistance system according to Supplementary Note 10, in which the extraction unit extracts, as the word of interest, a keyword having a largest number of times of utterance among keywords uttered during a predetermined period.

### [Supplementary Note 12]

The conference assistance system according to Supplementary Note 10 or 11, in which the provision unit generates the conference information including a history related to transition of the word of interest.

### [Supplementary Note 13]

The conference assistance system according to any one of Supplementary Notes 7 to 12, in which the terminal requests the server device to provide the conference information, and outputs the conference information acquired from the server device.

### [Supplementary Note 14]

The conference assistance system according to Supplementary Note 13, in which the terminal acquires a type of the conference information to which the participant desires to apply information, and requests provision of the conference information according to the acquired type of the conference information.

### [Supplementary Note 15]

The conference assistance system according to Supplementary Note 12, in which the terminal performs display indicating state transition of the word of interest based on the conference information including the history related to transition of the word of interest.

### [Supplementary Note 16]

A conference assistance method for a server device including:

generating minutes of a conference from statements of participants;

analyzing the generated minutes, thereby extracting a conference state word indicating a state of a discussion in a conference; and

generating conference information based on the conference state word and providing the generated conference information to a terminal.

### [Supplementary Note 17]

A computer readable storage medium storing a program causing a computer mounted on a server device to execute:

a process of generating minutes of a conference from statements of participants;

a process of analyzing the generated minutes, thereby extracting a conference state word indicating a state of a discussion in a conference; and

a process of generating conference information based on the conference state word and providing the generated conference information to a terminal.

The disclosures of the above citation list are incorporated herein by reference. Although the example embodiments of the present invention have been described above, the present invention is not limited to these example embodiments. It will be understood by those skilled in the art that these example embodiments are exemplary only and that various variations are possible without departing from the scope and spirit of the invention. That is, it goes without saying that the present invention includes various modifications and alterations that can be made by those skilled in the art in accordance with the entire disclosure including the claims and the technical idea.

### REFERENCE SIGNS LIST

10, 10-1 to 10-8 conference room terminal
11, 11-1 to 11-6 terminal
20, 100 server device
30 sound collecting microphone
40 projector
101 generation unit
102 extraction unit
103 provision unit
201, 301 communication control unit
202 user registration unit
203 participant specifying unit
204 minutes generation unit
205 conference state word extraction unit
206 information provision unit
207, 306 storage unit
211 user information acquisition unit
212 ID generation unit
213 feature value generation unit
214, 224 entry management unit
221 voice acquisition unit
222 text conversion unit
223 keyword extraction unit
302 face image acquisition unit
303 voice transmission unit
304 information provision request unit
305 conference information output unit
311 processor
312 memory
313 input/output interface
314 communication interface

What is claimed is:

1. A server device comprising:
at least one memory storing a set of instructions; and
at least one processor configured to execute the set of instructions to:
generate minutes of a conference from statements of participants;
analyze the generated minutes, thereby extracting a conference state word indicating a state of a discussion in a conference;
generate conference information based on the conference state word; and
provide the generated conference information to a terminal.

2. The server device according to claim 1, wherein the at least one processor is further configured to execute the instructions to analyze the minutes, thereby extracting a global word indicating directionality of an entire meeting.

3. The server device according to claim 2, wherein the at least one processor is further configured to execute the instructions to extracts, as the global word, a keyword having a largest number of times of utterance among keywords uttered during a period from start of the conference until the minutes are analyzed.

4. The server device according to claim 1, wherein the at least one processor is further configured to execute the instructions to analyze the minutes, thereby extracting a word of interest indicating a discussion in progress.

5. The server device according to claim 4, wherein the at least one processor is further configured to execute the instructions to extracts, as the word of interest, a keyword having a largest number of times of utterance among keywords uttered during a predetermined period.

6. The server device according to claim 4, wherein the at least one processor is further configured to execute the instructions to generate the conference information including a history related to transition of the word of interest.

7. A conference assistance system comprising:
a terminal that is used by a participant in a conference; and
a server device, wherein
the server device comprises:
at least one memory storing a set of instructions; and
at least one processor configured to execute the set of instructions to:
generate minutes of the conference from statements of participants;
analyze the generated minutes, thereby extracting a conference state word indicating a state of a discussion in the conference;
generate conference information based on the conference state word; and
provide the generated conference information to the terminal.

8. The conference assistance system according to claim 7, wherein the at least one processor is further configured to execute the instructions to analyze the minutes, thereby extracting a global word indicating directionality of an entire meeting.

9. The conference assistance system according to claim 8, wherein the at least one processor is further configured to execute the instructions to extract, as the global word, a keyword having a largest number of times of utterance among keywords uttered during a period from start of the conference until the minutes are analyzed.

10. The conference assistance system according to claim 7, wherein the at least one processor is further configured to execute the instructions to analyze the minutes, thereby extracting a word of interest indicating a discussion in progress.

11. The conference assistance system according to claim 10, wherein the at least one processor is further configured to execute the instructions to extract, as the word of interest, a keyword having a largest number of times of utterance among keywords uttered during a predetermined period.

12. The conference assistance system according to claim 10, wherein the at least one processor is further configured to execute the instructions to generate the conference information including a history related to transition of the word of interest.

13. The conference assistance system according to claim 7, wherein the terminal requests the server device to provide the conference information, and outputs the conference information acquired from the server device.

14. The conference assistance system according to claim 13, wherein the terminal acquires a type of the conference information to which the participant desires to apply information, and requests provision of the conference information according to the acquired type of the conference information.

15. The conference assistance system according to claim 12, wherein the terminal performs display indicating state transition of the word of interest based on the conference information including the history related to transition of the word of interest.

16. A conference assistance method for a server device comprising:
generating minutes of a conference from statements of participants;
analyzing the generated minutes, thereby extracting a conference state word indicating a state of a discussion in a conference; and
generating conference information based on the conference state word and providing the generated conference information to a terminal.

17. (canceled)
